(19) United States
(12) Patent Application Publication
(10) Pub. No.: US 2008/0066338 A1
(43) Pub. Date: Mar. 20, 2008

(54) Horn or antler stabilizer

(76) Inventor: D. Blake Cox, Kernersville, NC (US)

Correspondence Address: D. Blake Cox, 5385 ValleyDale Rd., P.O. Box 1774, Kernersville, NC, 27285, US

(21) Appl. No.: 11/901,223

(22) Filed: Sep. 17, 2007

Related U.S. Application Data
(60) Provisional application No. 60/845,822, filed on Sep. 19, 2006.

(51) Int. Cl. F26B 19/00

(52) U.S. Cl. 34/388; 34/239; 34/440; 403/43

(57) ABSTRACT

The horn or antler stabilizer includes threaded rods contained within a central body which can be adjusted to contact and grip opposing antlers to allow the antlers to dry without shrinking.

This non-provisional patent application claims all benefits under 35 U.S.C. §119(e) of pending U.S. provisional patent application Ser. No. 60/845,822 filed 19 Sep. 2006, entitled “HORN OR ANTLER STABILIZER”, in the United States Patent and Trademark Office.

### FIELD OF THE INVENTION

The invention herein pertains to a stabilizing device and particularly pertains to a stabilizing device used while drying horns or antlers.

### OBJECTIVE OF THE INVENTION

It is the main objective of the present invention to provide a simple and efficient means for stabilizing antlers during the drying process.

Various other objectives and advantages of the present invention will become apparent to those skilled in the art as a more detailed description is set forth below.

### BRIEF SUMMARY OF THE INVENTION

A horn or antler stabilizer is provided which includes a body with a pair of threaded rods. The rods can be extended from the body into contact with the antlers to prevent the antlers from shrinking as they dry.

### BRIEF DESCRIPTION OF THE VIEWS OF THE DRAWINGS

FIG. 1 is a top view of the horn or antler stabilizer with left and right threaded rods.

FIG. 2 is a schematic top view of the horn or antler stabilizer installed between horns or antlers.

### DETAILED DESCRIPTION OF THE INVENTION

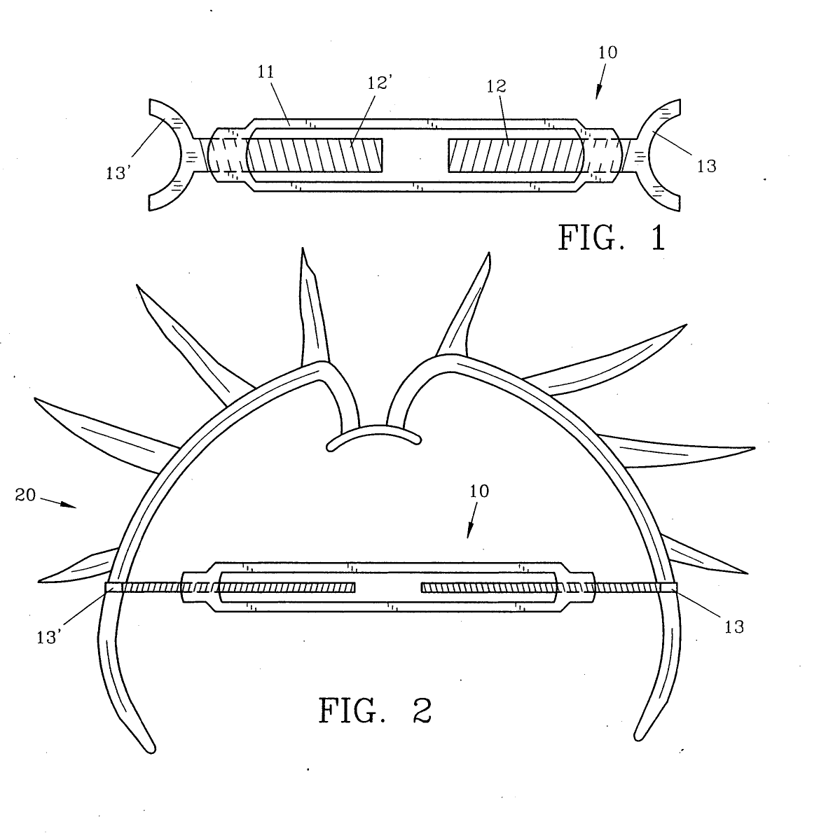

Antler stabilizer 10 with body 11 as seen in FIG. 1 has right and left screw out or threaded rods 12, 12′ with U-shaped ends 13, 13′ respectively for placement of stabilizer 10 between antlers 20 as shown in FIG. 2. By turning rods 12, 12′ clockwise and/or counter clockwise the screw out rods 12, 12′ with U-shaped ends 13, 13′ can be adjusted in or out to the desired width to keep the horns or antlers 20 from shrinking while going through a drying period.

The method of use of stabilizer 10 includes the steps of: placing stabilizer 10 against antlers 20 and adjusting threaded rods 12, 12′ against antlers 20 to stabilize antlers 20.

1. An antler stabilizer comprising a body, a first threaded rod, said first threaded rod rotatably contained within said body, said stabilizer for placement between a pair of antlers to stabilize the antlers while drying.

2. The antler stabilizer of claim 1 wherein said first-threaded rod is adjustable.

3. The antler stabilizer of claim 1 further comprising a second threaded rod, said second threaded rod contained within said body.

4. The antler stabilizer of claim 3 wherein said first threaded rod comprises a U-shaped end.

5. A method of preventing antler shrinkage using a stabilizer having a body with a threaded rod comprising the steps of:
a) placing the stabilizer against the antlers; and
b) adjusting the threaded rod against the antlers to stabilize the antlers.

6. The method of claim 5 wherein placing the stabilizer against the antlers comprises the step of placing the stabilizer between the antlers.

7. The method of claim 5 wherein adjusting the threaded rod comprises the step of turning a rod having a U-shaped end.
